(19) United States
(12) Patent Application Publication
(10) Pub. No.: US 2023/0384426 A1
(43) Pub. Date: Nov. 30, 2023

(54) LASER SENSOR, CONTROL METHOD OF LASER SENSOR, AND RECORDING MEDIUM STORING CONTROL PROGRAM OF LASER SENSOR

(71) Applicant: Fujitsu Limited, Kawasaki-shi (JP)

(72) Inventors: Arata EJIRI, Machida (JP); Koichi IIDA, Kobe (JP); Katsushi SAKAI, Zama (JP)

(73) Assignee: Fujitsu Limited, Kawasaki-shi (JP)

(21) Appl. No.: 18/158,815

(22) Filed: Jan. 24, 2023

(30) Foreign Application Priority Data
May 24, 2022 (JP) 2022-084410

(51) Int. Cl. G01S 7/481; G01S 17/10; G01S 7/4865

(52) U.S. Cl. CPC G01S 7/4816; G01S 17/10; G01S 7/4817; G01S 7/4865

(57) ABSTRACT

A laser sensor includes: a mirror configured to scan a reflection angle of laser light; a driving waveform generation circuit configured to generate a waveform of a driving signal that controls an amplitude of the mirror, according to an amplitude command value based on a target amplitude that defines a scanning range of the mirror; and a feedforward circuit configured to reflect a transient model in a case where the amplitude of the mirror transiently changes with time according to the driving signal in a case where the target amplitude is changed and a target model of a temporal change of the amplitude of the mirror on the amplitude command value through feedforward control.

### CROSS-REFERENCE TO RELATED APPLICATION

This application is based upon and claims the benefit of priority of the prior Japanese Patent Application No. 2022-84410, filed on May 24, 2022, the entire contents of which are incorporated herein by reference.

### FIELD

The embodiment discussed herein is related to a laser sensor.

### BACKGROUND

A laser sensor that includes a mirror such as a micro electro mechanical system (MEMS) mirror, a light emission element, and a light receiving element has been developed.

Japanese Laid-open Patent Publication No. 2020-77415 is disclosed as related art.

### SUMMARY

According to an aspect of the embodiments, a laser sensor includes: a mirror configured to scan a reflection angle of laser light; a driving waveform generation circuit configured to generate a waveform of a driving signal that controls an amplitude of the mirror, according to an amplitude command value based on a target amplitude that defines a scanning range of the mirror; and a feedforward circuit configured to reflect a transient model in a case where the amplitude of the mirror transiently changes with time according to the driving signal in a case where the target amplitude is changed and a target model of a temporal change of the amplitude of the mirror on the amplitude command value through feedforward control.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an overall configuration of a measurement system according to an embodiment;

FIG. 2 is an explanatory diagram of a time-of-flight (TOF) technology;

FIG. 3A is a diagram illustrating a vertical driving signal generated by a driving signal generation unit according to a timing of a frame pulse, and FIG. 3B is a diagram illustrating a horizontal driving signal generated by a driving waveform generation unit according to a timing of a line pulse;

FIG. 4 is a diagram illustrating a relationship between an ineffective pixel area and an effective pixel area;

FIGS. 5A and 5B are diagrams for explaining zoom control;

FIG. 6 is a diagram for explaining the zoom control;

FIG. 7 is a diagram illustrating feedforward control;

FIG. 8 is a diagram illustrating amplitude return changes in a case where only feedback control is performed without adding a feedforward term and a case where the feedforward term is added to the feedback control;

FIG. 9 is a diagram illustrating an overall configuration of a laser sensor according to a first embodiment;

FIG. 10 is a diagram illustrating a transient model Gp;

FIG. 11 is a diagram illustrating actual machine data in a case where a maximum angle of an amplitude in a horizontal direction is expanded from 32° to 36°;

FIG. 12A illustrates each Y-axis light emission section of the laser sensor, and FIG. 12B illustrates a target model Gd in a case where the maximum angle of the amplitude in the horizontal direction is expanded from 32° to 36°;

FIG. 13 is a flowchart illustrating an example of an operation of the laser sensor in a case where a target amplitude is changed from 32° to 36°;

FIG. 14 is a diagram illustrating a control result in a case where the target amplitude has been changed from 32° to 36°;

FIG. 15A is a diagram illustrating frequency characteristics of a steady model, and FIG. 15B is a diagram illustrating frequency characteristics of a transient model; and

FIG. 16 is a block diagram for explaining a hardware configuration.

### DESCRIPTION OF EMBODIMENTS

There is a case where a high frequency driving waveform is input to control an angle of a mirror. In this case, it is desirable to be able to control the angle of the mirror at high speed. However, when trying to change the angle of the mirror at high speed, there is a possibility that the angle of the mirror is unstable.

In one aspect, an object of this case is to provide a laser sensor that can stably change an angle of a mirror.

Before description of embodiments, problems of a laser sensor will be described.

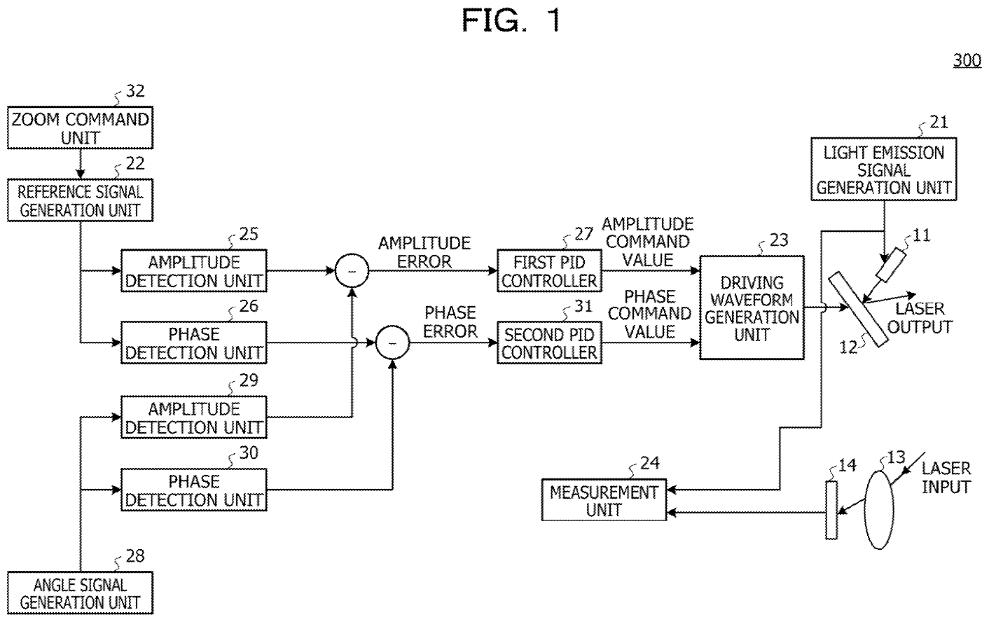

FIG. 1 is a schematic diagram of a laser sensor 300 according to a comparative example. As illustrated in FIG. 1, the laser sensor 300 includes a light emission device 11, a MEMS mirror 12, a light receiving lens 13, a light receiving element 14, or the like as a light emission system. Furthermore, the laser sensor 300 includes a light emission signal generation unit 21, a reference signal generation unit 22, a driving waveform generation unit 23, a measurement unit 24, an amplitude detection unit 25, a phase detection unit 26, a first proportional-integral-differential (PID) controller 27, an angle signal generation unit 28, an amplitude detection unit 29, a phase detection unit 30, a second PID controller 31, a zoom command unit 32, or the like as a control system.

The light emission device 11 is a device that emits laser light in response to an instruction of the light emission signal generation unit 21 and includes a light emission element such as a semiconductor laser. As an example, the light emission device 11 emits pulsed light with a predetermined sampling period, in response to the instruction of the light emission signal generation unit 21. A timing when the light emission signal generation unit 21 instructs the light emission device 11 to emit the pulsed light is sent to the measurement unit 24. For example, the measurement unit 24 acquires a pulsed light emission timing.

The MEMS mirror 12 is a micro electro mechanical system mirror, and is a mirror that changes an angle of three-dimensionally emitted laser light. The MEMS mirror 12 is a two-axis rotation type mirror, in which the angle of emitted laser light changes three-dimensionally, for example, in response to changes in a rotation angle of a horizontal axis and a rotation angle of a vertical axis. The rotation angle of the horizontal axis is referred to as a horizontal angle H, and the rotation angle of the vertical axis is referred to as a vertical angle V. The driving waveform generation unit 23 controls the horizontal angle H and the vertical angle V of the MEMS mirror 12 using a driving waveform used to instruct the horizontal angle H and the vertical angle V of the MEMS mirror 12, according to a reference signal generated by the reference signal generation unit 22. The pulsed light emitted from the light emission device 11 is deflected according to the horizontal angle H and the vertical angle V of the MEMS mirror 12.

Pulsed light reflected by the MEMS mirror 12 is applied to a ranging target, is scattered (reflected), and returns to the light receiving lens 13. This returning light is collected by the light receiving lens 13 and is received by the light receiving element 14.

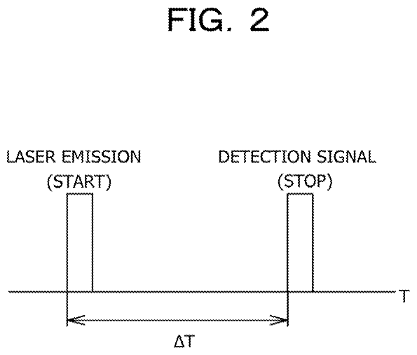

The measurement unit 24 measures a distance to the ranging target by adopting the Time OF Flight (TOF) technology. FIG. 2 is an explanatory diagram of the TOF technology. As illustrated in FIG. 2, the measurement unit 24 measures a round-trip time (ΔT) from when the light emission device 11 emits a laser pulse to when the returning light returns from the ranging target, and calculates the distance to the ranging target by multiplying the measured round-trip time by the speed of light. Since the measurement unit 24 can measure a distance each time when the light emission device 11 emits pulsed light, the measurement unit 24 can measure a distance with a sampling period.

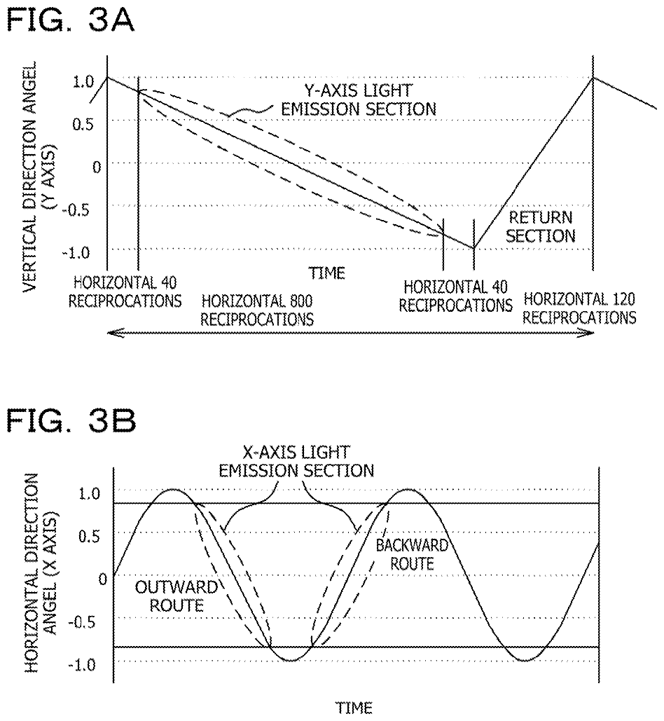

The MEMS mirror 12 scans reflected light from the light emission device 11 within a scanning range by driving on the two axes, namely, the vertical axis and the horizontal axis. FIG. 3A is a diagram illustrating a vertical driving signal generated by the driving waveform generation unit 23 according to a timing of a frame pulse (vertical driving timing signal). The frame pulse is a signal output by the MEMS mirror 12 at a scanning start timing of the scanning range. Therefore, the frame pulse is output every time when the MEMS mirror 12 scans the scanning range once.

In FIG. 3A, the horizontal axis indicates an elapsed time, and the vertical axis indicates a relative scanning angle in the vertical direction. The number “1” on the vertical axis represents the smallest scanning angle in the vertical direction. The number “−1” on the vertical axis represents the largest scanning angle in the vertical direction. Reciprocation of the relative scanning angle in the vertical direction between “−1” and “1” reciprocates the scanning angle in the vertical direction once.

Reciprocation of the scanning angle in the vertical direction is completed from the timing of the frame pulse to the timing of the subsequent frame pulse. As an example, the scanning angle in the vertical direction linearly changes from “1” to “−1” while the reciprocation in the horizontal direction is performed 880 times. Thereafter, the scanning angle in the vertical direction linearly changes from “−1” to “1” while the reciprocation in the horizontal direction is performed 120 times. In this manner, while the reciprocation in the horizontal direction is performed 1000 times, the reciprocation in the vertical direction is performed once. A frequency at which the reciprocation in the vertical direction is repeated is about 28 Hz, and a frequency at which the reciprocation in the horizontal direction is repeated is about 28 kHz.

FIG. 3B is a diagram illustrating a horizontal driving signal generated by the driving waveform generation unit 23 according to a timing of a line pulse (horizontal driving timing signal). The line pulse is a signal output by the MEMS mirror 12 at a scanning start timing for each line in the scanning range. Therefore, the line pulse is output each time when the MEMS mirror 12 scans each line once. As an example, the line pulse is output 1000 times in one period of the frame pulse.

In FIG. 3B, the horizontal axis indicates an elapsed time, and the vertical axis indicates a relative scanning angle in the horizontal direction. The number “−1” on the vertical axis represents the smallest scanning angle in the horizontal direction. The number “1” on the vertical axis represents the largest scanning angle in the horizontal direction. Reciprocation of this relative scanning angle in the horizontal direction between “−1” and “1” reciprocates the scanning angle in the horizontal direction once. The horizontal driving signal is a sine wave.

One reciprocation of the scanning angle in the horizontal direction is completed from the timing of the line pulse to the timing of the next line pulse. In the present embodiment, as an example, distances of 40 points are measured in an outward route from “0.95” to “−0.95” (X-axis light emission section), and distances of 40 points are measured in a backward route from next “−0.95” to “0.95” (X-axis light emission section). A time interval of the distance measurement is 320 ns, as an example.

As an example, until 40 reciprocations in the horizontal direction are performed from the timing of the frame pulse, the light emission device 11 does not emit light. Thereafter, while 800 reciprocations in the horizontal direction are performed, the light emission device 11 emits light. This light emission section is referred to as a Y-axis light emission section. While next 40 times of reciprocations in the horizontal direction are performed, the light emission device 11 does not emit light. Moreover, in a return section thereafter in which 120 reciprocations in the horizontal direction are performed, the light emission device 11 does not emit light.

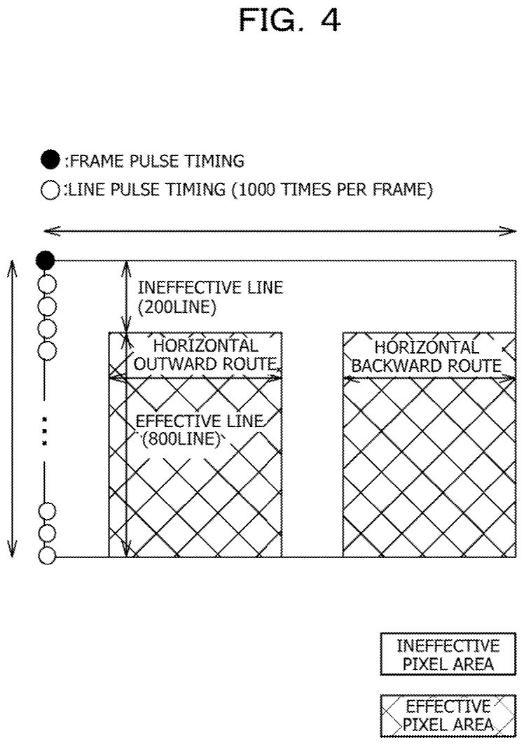

FIG. 4 is a diagram illustrating a relationship between an ineffective pixel area and an effective pixel area during such one reciprocation in the vertical direction. The example in FIG. 4 represents raster scanning specifications. The effective pixel area is an area where distance measurement is performed through light emission by the light emission device 11. The ineffective pixel area is an area where distance measurement through light emission is not performed. Therefore, in the ineffective pixel area, the light emission device 11 does not emit light. As illustrated in FIG. 4, the number of ineffective lines is 200, and the number of effective lines is 800. Furthermore, a part of a horizontal outward route is given as an effective pixel area, and a part of a horizontal backward route is given as an effective pixel area.

With such a laser sensor, there is a possibility that a screen is distorted depending on a temperature change or a position in the screen. Therefore, by respectively comparing a target amplitude and a target phase of the MEMS mirror 12 and an actual amplitude and an actual phase of the MEMS mirror 12 and individually performing feedback control, it is possible to control the amplitude and the phase and reduce the distortion of the screen.

For example, the amplitude detection unit 25 detects a target amplitude included in the reference signal. The amplitude here indicates a range width of the angle of the MEMS mirror 12 in the horizontal direction. The target amplitude indicates a target value of the amplitude. Furthermore, the phase detection unit 26 detects a target phase included in the reference signal. The phase here indicates a phase of a sine wave representing an angle change of the MEMS mirror 12 in the horizontal direction. The target phase indicates a target value of the phase.

The angle signal generation unit 28 measures an actual angle of the MEMS mirror 12 and generates an angle signal including the measured angle as information. For example, the angle signal generation unit 28 acquires a measured value from a sensor that measures the actual angle of the MEMS mirror 12 and generates the angle signal from the measured value. The amplitude detection unit 29 detects an amplitude measured value included in the angle signal. The phase detection unit 30 detects a phase measured value included in the angle signal.

If a difference (amplitude error) between the target amplitude detected by the amplitude detection unit 25 and the amplitude measured value detected by the amplitude detection unit 29 does not exceed a threshold, the first PID controller 27 sends an amplitude command value with which the target amplitude is realized to the driving waveform generation unit 23. If the amplitude error exceeds the threshold, the first PID controller 27 performs feedback control on the amplitude command value so that the difference (amplitude error) between the target amplitude detected by the amplitude detection unit 25 and the amplitude measured value detected by the amplitude detection unit 29 decreases. The driving waveform generation unit 23 generates a driving waveform according to the amplitude command value received from the first PID controller 27.

If a difference (phase error) between the target phase detected by the phase detection unit 26 and the phase measured value detected by the phase detection unit 30 does not exceed a threshold, the second PID controller 31 sends a phase command value with which the target phase is realized to the driving waveform generation unit 23. If the phase error exceeds the threshold, the second PID controller 31 performs feedback control on the phase command value so as to reduce the phase error. The driving waveform generation unit 23 corrects the driving waveform according to the phase command value received from the second PID controller 31.

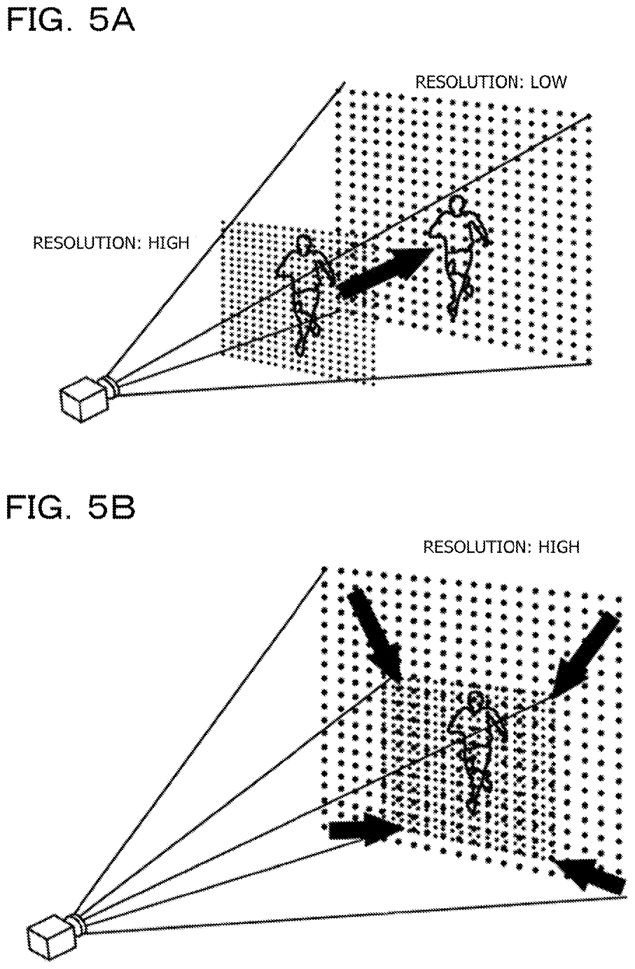

By the way, when an angle of view of the laser sensor 300 is fixed, a resolution of the ranging target changes according to a distance from the laser sensor 300 to the ranging target. For example, as illustrated in FIG. 5A, if the ranging target is separated from the laser sensor 300, a range of the ranging target with respect to the scanning range is relatively narrowed, and accordingly, the resolution is deteriorated. Therefore, the laser sensor 300 may perform a zoom operation for changing the scanning range according to a movement of the ranging target, in order to ensure a predetermined resolution for an increase in the distance. For example, as illustrated in FIG. 5B, when the ranging target is separated from the laser sensor 300, zoom control for dynamically changing the angle of view and narrowing the scanning range is performed, and the deterioration in the resolution is suppressed.

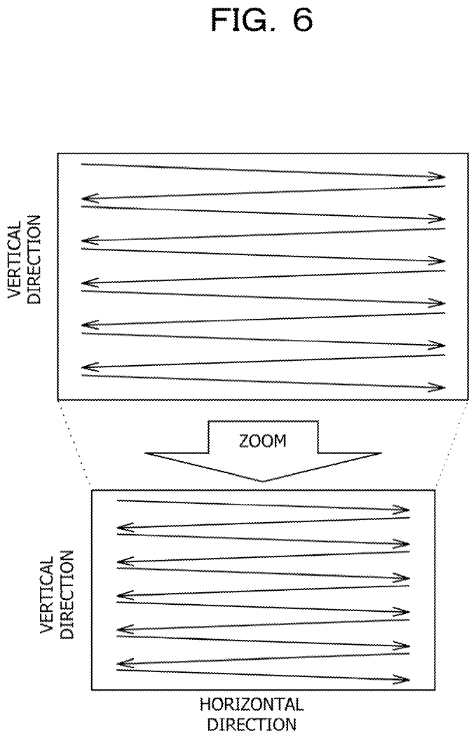

FIG. 6 is a diagram illustrating scanning in the horizontal direction in a case where the scanning range is narrowed. As illustrated in FIG. 6, when a distance from the laser sensor 300 to the ranging target is shortened, the zoom command unit 32 commands the reference signal generation unit 22 to reduce the target amplitude in the horizontal direction. Therefore, the reference signal generation unit 22 reduces the target amplitude included in the reference signal. Conversely, if the distance from the laser sensor 300 to the ranging target is increased, the zoom command unit 32 commands the reference signal generation unit 22 to expand the target amplitude in the horizontal direction. Therefore, the reference signal generation unit 22 increases the target amplitude included in the reference signal.

In order to continuously perform distance measurement while performing such zoom control, it is desirable to expand or reduce the scanning range in the horizontal direction at high speed before a next Y-axis light emission section and accurately control an amplitude so as to match the expanded or reduced scanning range. For example, it is considered that the first PID controller 27 sends the amplitude command value to the driving waveform generation unit 23 through feedback control so as to reduce the amplitude error between the changed target amplitude and the amplitude measured value. In this case, a step value of the feedback control is used to change the amplitude command value in a stepwise manner. However, if a response by the first PID controller 27 is late, it is difficult to control the amplitude before a next light emission section.

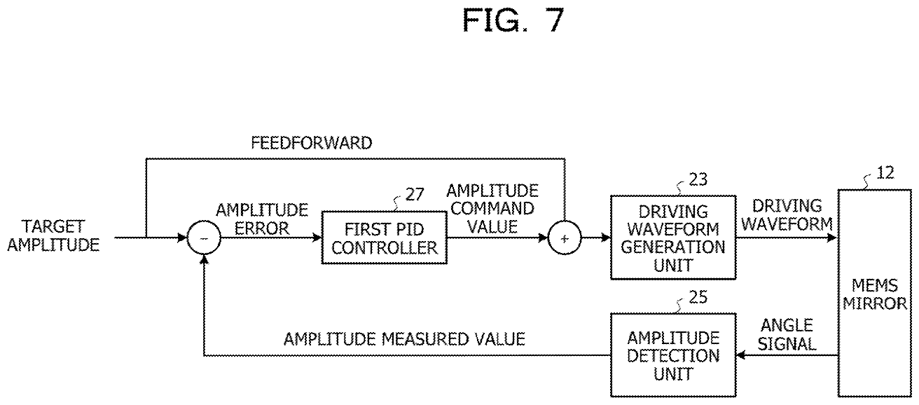

Therefore, as illustrated in FIG. 7, it is considered that a feedforward term is added and the changed target amplitude is input to the driving waveform generation unit 23 as an amplitude command value. However, a problem is caused such that an amplitude error in the next light emission section increases due to transient characteristics (response delay, vibration characteristics, or the like) of the MEMS mirror 12.

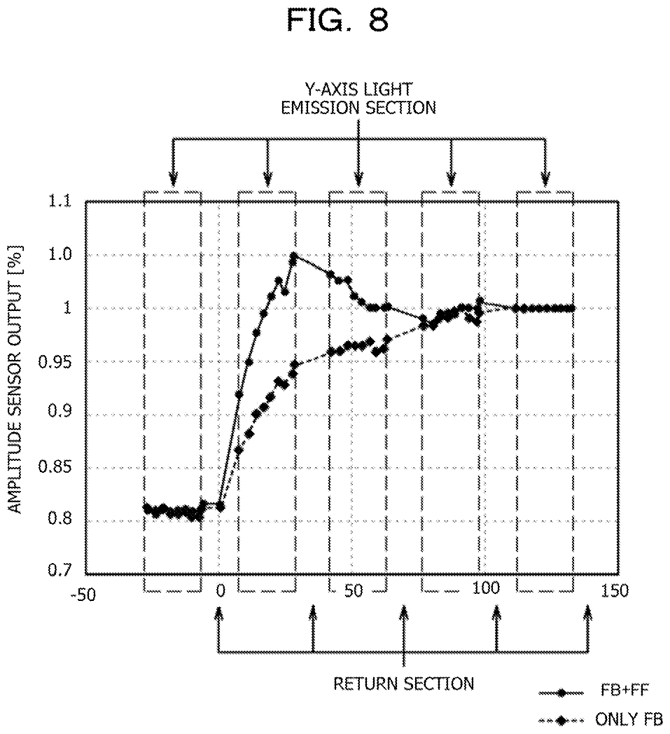

FIG. 8 is a diagram illustrating amplitude return changes in a case where only feedback control is performed without adding a feedforward term (only FB) and in a case where the feedforward term is added to feedback control (FB+FF). As illustrated in FIG. 8, in a case of only the feedback control, several Y-axis light emission sections are passed before an amplitude sensor output (ratio of amplitude measured value with respect to target amplitude) returns to about 100%. On the other hand, if the feedforward term is added, a response is more quickly made. However, the amplitude sensor output exceeds 100% (overshoot).

In this way, in a case where the zoom control for changing the scanning range is performed according to the movement of the ranging target, a problem occurs in that amplitude control is not in time for the next Y-axis light emission section. Therefore, for example, it is considered to increase responsiveness of an amplitude feedback system. However, since an amplitude value is detected only twice in one period in the horizontal direction, it is difficult to increase the responsiveness any more in principle. If the feedforward term is added, as described above, there is a possibility that the amplitude error increases due to the transient characteristics of the MEMS mirror 12.

Therefore, in the following embodiment, a laser sensor that can stably change an angle of a mirror will be described.

### First Embodiment

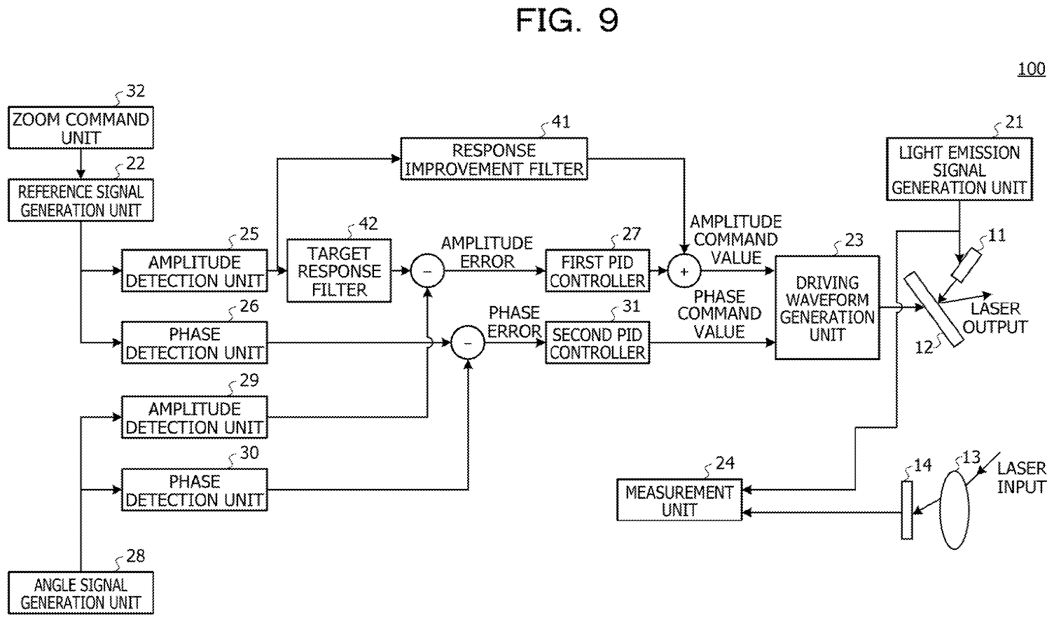

FIG. 9 is a diagram illustrating an overall configuration of a laser sensor 100 according to a first embodiment. Components same as those of the laser sensor 300 according to the comparative example are denoted with the same reference numerals, and description thereof will be omitted. As illustrated in FIG. 9, the laser sensor 100 is different from the laser sensor 300 in that a response improvement filter 41 and a target response filter 42 are further included. The response improvement filter 41 filters response improvement using a ratio between a target model Gd and a transient model Gp. The target response filter 42 filters a target response using the target model Gd.

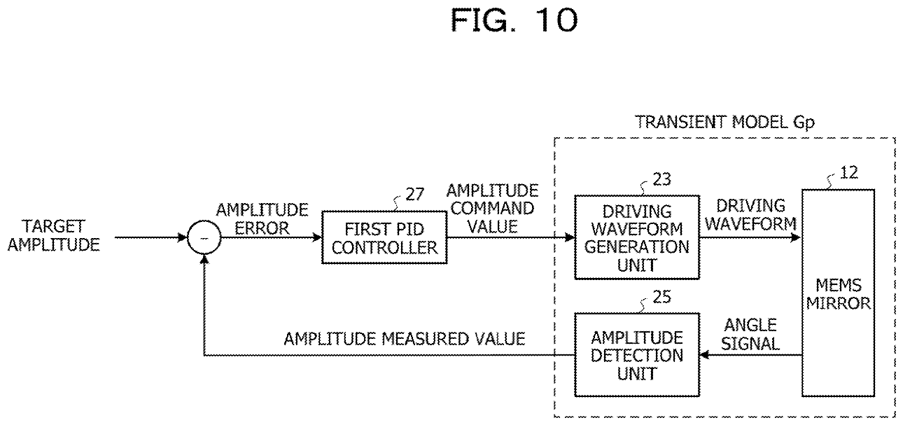

The transient model Gp is obtained by modeling a result of a measured amplitude value detected by an amplitude detection unit 29, in a case where a MEMS mirror 12 is driven by using a driving waveform generated by a driving waveform generation unit 23, as illustrated in FIG. 10, in a case where a target amplitude is changed. For example, the transient model Gp is a model of actual machine data in a case where an operation is actually performed using an actual machine. As an example, the transient model Gp in a case where the target amplitude is changed from 32° to 36° will be described.

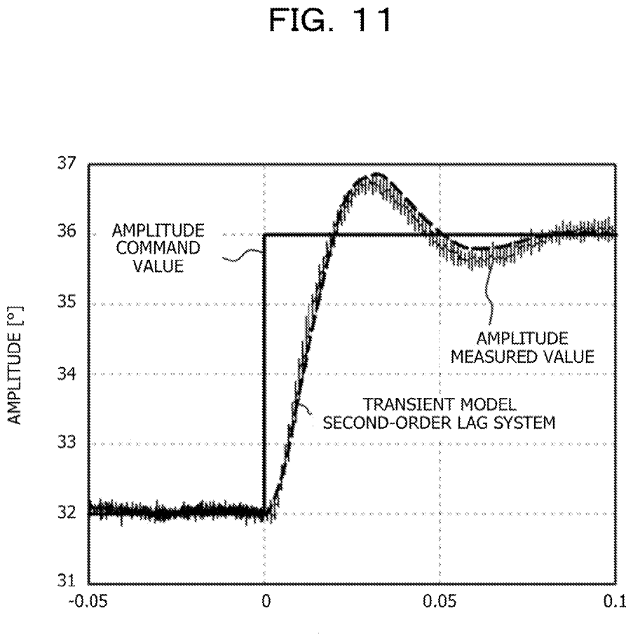

FIG. 11 is a diagram illustrating actual machine data in a case where a maximum angle of an amplitude in a horizontal direction is expanded from 32° to 36°. In FIG. 11, the horizontal axis indicates an elapsed time, and the vertical axis indicates an amplitude. In a process for creating this transient model Gp, feedback of the amplitude is not performed. Therefore, the target amplitude and an amplitude command value match. Therefore, as illustrated in FIG. 11, before the target amplitude is changed, the amplitude command value is fixed to 32°. At a time point when the elapsed time is zero seconds (s), the target amplitude is changed, and the amplitude command value is changed to 36°. In the example in FIG. 11, the amplitude measured value gradually increases for each elapsed time after the driving waveform is sent to the MEMS mirror 12 and gradually fixed at 36°. For example, the transient model Gp can be obtained by approximating a transfer function model of a second-order lag system with respect to the actual machine data using the following formula. FIG. 11 also illustrates the transient model Gp. Note that “fp” represents a response frequency. “ξ” represents an attenuation coefficient. By creating the transient model Gp in this way, actual operation content before the target amplitude is realized can be acquired in advance.

$$Gp ( s ) = \frac{k}{{s}^{\hat{}} 2 + 2 π fp ζ \cdot s + {( 2 π fp )}^{\hat{}} 2} \qquad [ Expression 1 ]$$

The target model Gd is an ideal model of a response and a convergence of the MEMS mirror 12 in a period from a time point when a Y-axis light emission section ends to a next Y-axis light emission section (td [s]). For example, the target model Gd is a model of which a measured amplitude value in the horizontal direction is within an allowable range in the period (td [s]). The target model Gd is created by a manufacturer of the laser sensor 100, a user of the laser sensor 100, or the like in advance.

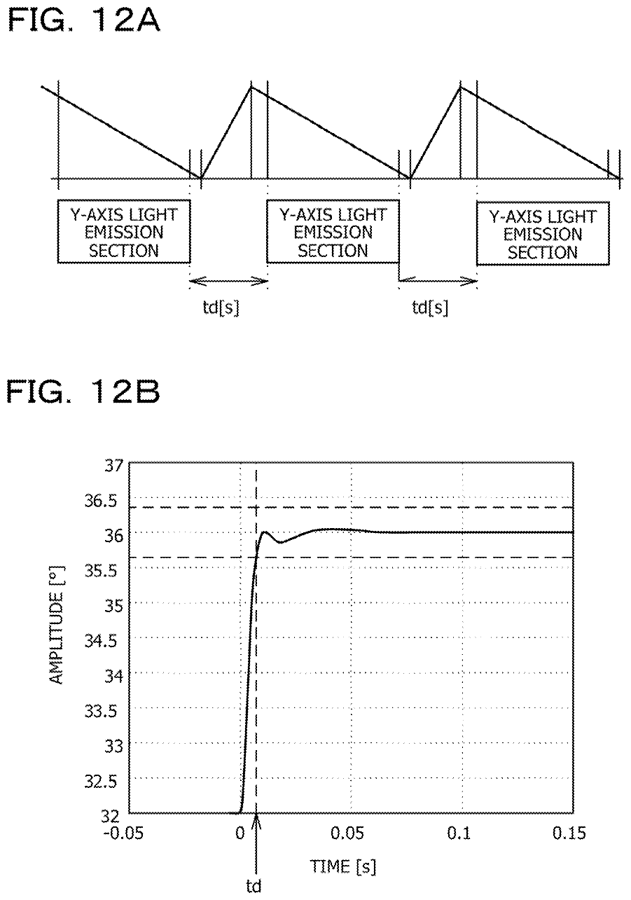

FIG. 12A illustrates each Y-axis light emission section of the laser sensor 100. FIG. 12B illustrates a target model Gd in a case where the maximum angle of the amplitude in the horizontal direction is expanded from 32° to 36°. In FIG. 12B, the horizontal axis indicates an elapsed time, and the vertical axis indicates an amplitude of the MEMS mirror 12 in the horizontal direction. As illustrated in FIG. 12B, before the target amplitude is changed, the amplitude command value is substantially fixed to be 32°. It is assumed that the target amplitude be changed at a time point when the elapsed time is zero seconds (s), and the amplitude command value is changed for each elapsed time from 32° to 36°. In the example in FIG. 12B, the amplitude is gradually increased after the target amplitude is changed and to be gradually fixed at 36°. Furthermore, the measured amplitude value in the horizontal direction is set to be within the allowable range in the period from the time point when the Y-axis light emission section ends to the next Y-axis light emission section (td [s]). For example, the target model Gd can be approximated with a transfer function model of a second-order Butterworth pole of which responsiveness and stability are balanced as in the following formula. The reference “fd” represents a response frequency.

$$Gd ( s ) = \frac{1 / {( 2 π fd )}^{\hat{}} 2}{{s}^{\hat{}} 2 + 4 π fd \cdot s + {( 2 π fd )}^{\hat{}} 2} \qquad [ Expression 2 ]$$

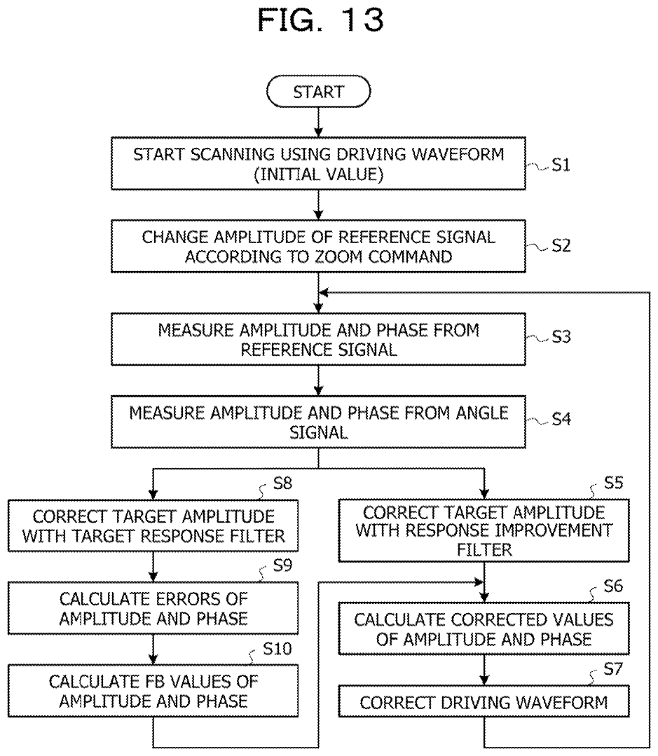

Subsequently, operations using the transient model Gp and the target model Gd will be described. FIG. 13 is a flowchart illustrating an example of an operation of the laser sensor 100 in a case where the target amplitude is changed from 32° to 36°. As illustrated in FIG. 13, the driving waveform generation unit 23 sends a driving waveform (initial value) to the MEMS mirror 12 in response to an instruction from a reference signal generation unit 22. As a result, scanning using the driving waveform (initial value) is started (step S1). In this case, feedback control to eliminate the amplitude error is performed by a first PID controller 27, and feedback control to eliminate the phase error is performed by a second PID controller 31. As an example, it is assumed that the target amplitude be specified as 32°.

Upon receiving a target amplitude change instruction from a zoom command unit 32, the reference signal generation unit 22 changes a target amplitude of a reference signal according to the change instruction (step S2). For example, it is assumed that the target amplitude be changed to 36°.

Next, the amplitude detection unit 25 detects the target amplitude from the reference signal. Furthermore, the phase detection unit 26 detects the target phase from the reference signal (step S3).

The amplitude detection unit 29 detects an amplitude measured value from an angle signal generated by an angle signal generation unit 28. The phase detection unit 30 detects a phase measured value from the angle signal (step S4).

The response improvement filter 41 corrects the target amplitude with the response improvement filter using a ratio between the target model Gd and the transient model Gp (step S5). For example, for each elapsed time, the target amplitude is multiplied by the ratio of (amplitude value of target model Gd)/(amplitude value of transient model Gp).

Thereafter, the driving waveform generation unit 23 calculates corrected values of the amplitude and the phase according to the amplitude command value obtained through the processing in step S5 (step S6).

Next, the driving waveform generation unit 23 corrects the driving waveform according to the corrected value calculated in step S6 (step S7). Thereafter, the processing is executed again from step S3. As a result, the series of processing from step S3 to step S7 is repeatedly executed, for each elapsed time.

By using the amplitude value of the transient model Gp as a denominator, an actual operation before the target amplitude of the laser sensor 100 is realized is canceled, and the operation of the laser sensor 100 matches the target model Gd. As a result, the measured amplitude value in the horizontal direction is set to be within the allowable range and the operation of the MEMS mirror 12 becomes stable in the period from the time point when the Y-axis light emission section ends to the next Y-axis light emission section (td [s]).

On the other hand, there is a possibility that the amplitude error and the phase error occur, due to an effect of disturbances or the like. Therefore, after step S4 is executed, the series of processing from step S8 to step S10 is executed in parallel to step S5. For example, the target response filter 42 corrects the target amplitude with the target response filter using the target model Gd (step S8). For example, the target amplitude included in the reference signal is replaced with an amplitude value of the target model Gd for each elapsed time. Through this processing, the amplitude error can be calculated with reference to the target model Gd.

Next, the amplitude detection unit 29 detects the amplitude measured value included in the angle signal. The phase detection unit 30 detects a phase measured value included in the angle signal. As a result, the amplitude error and the phase error are calculated (step S9).

Next, the first PID controller 27 calculates a feedback value (corrected value) of the amplitude so as to reduce the amplitude error. The second PID controller 31 calculates a feedback value (corrected value) of the phase so as to eliminate the phase error (step S10). Thereafter, step S6 is executed.

By separately executing step S5 and the series of processing from step S8 to step S10, it is possible to separately set response characteristics for the target amplitude and suppression characteristics for the disturbance.

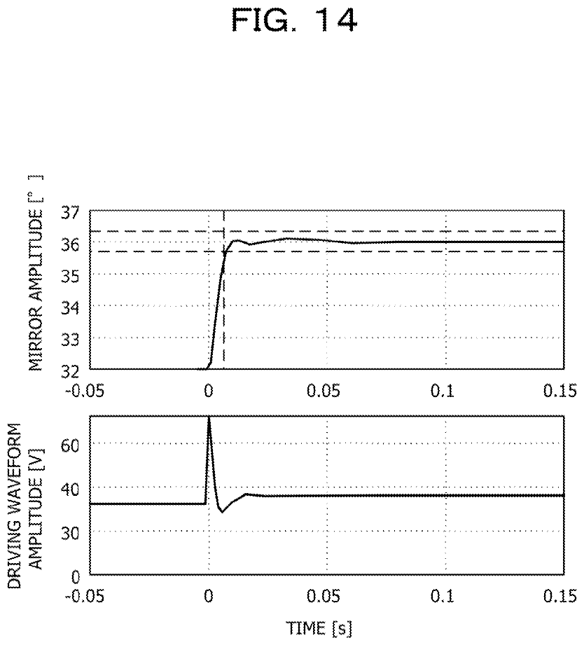

FIG. 14 is a diagram illustrating a control result in a case where the target amplitude has been changed from 32° to 36°. As illustrated in the upper portion of FIG. 14, it is found that a temporal change of the amplitude of the MEMS mirror 12 in the horizontal direction substantially matches the target model Gd and the angle of the MEMS mirror 12 can be stably changed. Note that, in the lower portion of FIG. 14, a voltage value of a driving waveform amplitude is illustrated.

Here, a difference between a transient model and a steady model of the MEMS mirror 12 will be described. As described above, the transient model is an operation model in a case where the target amplitude of the MEMS mirror 12 in the horizontal direction is changed through zoom control or the like. The steady model is an operation model in a case where the target amplitude of the MEMS mirror 12 in the horizontal direction is not changed. The difference between the steady model and the transient model can be expressed as in Table 1.

TABLE 1

| | Steady model | Transient model |
|---|---|---|
| Input | Driving current voltage | Driving current voltage |
| | | amplitude |
| Output | Angle sensor output | Angle sensor output |
| | | amplitude |
| Driving sine wave | Frequency and | Frequency is fixed, |
| | amplitude are fixed | amplitude fluctuates |
| Feature | Represent input/output | Represent transient |
| | ratio and phase when | behavior of |
| | driving is performed at | input/output ratio when |
| | fixed frequency and | amplitude is changed |
| | fixed amplitude. | with fixed frequency |
| | | drive. |
| | | Model that considers |
| | | input sine wave. |

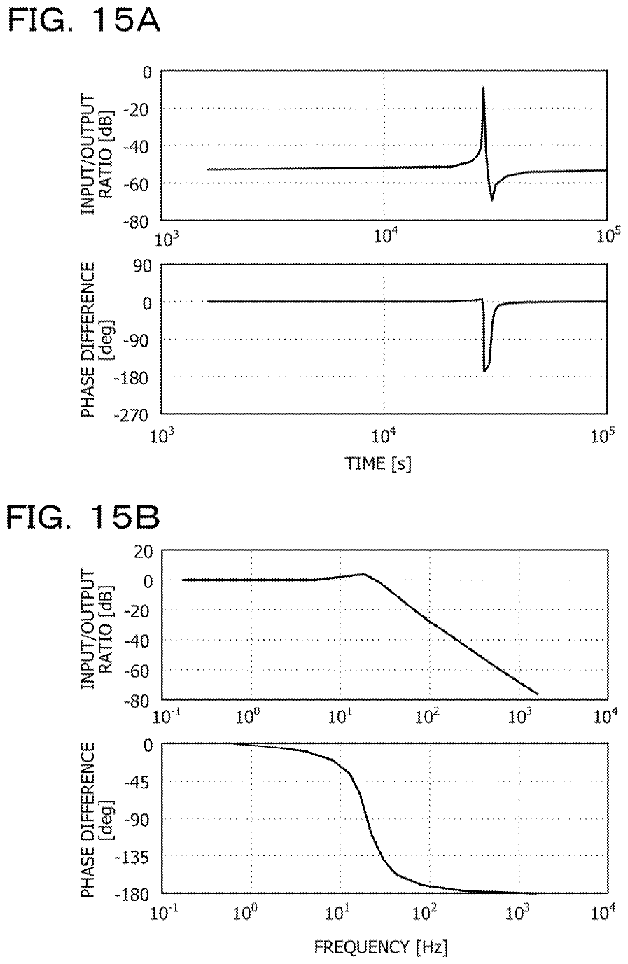

First, an input of the steady model is a driving current voltage. An input of the transient model is a driving current voltage amplitude. Next, an output of the steady model is an output of an angle sensor that detects the angle of the MEMS mirror 12. An output of the transient model is an output amplitude of the angle sensor. Next, a driving sine wave of the steady model represents an input/output ratio and a phase when driving is performed at a fixed frequency and a fixed amplitude. The driving sine wave of the transient model represents a transient behavior of the input/output ratio when the amplitude is changed with fixed frequency drive, and the driving sine wave of the transient model is a model that considers an input sine wave. FIG. 15A is a diagram illustrating frequency characteristics of the steady model. FIG. 15B is a diagram illustrating frequency characteristics of the transient model.

Here, a theoretical formula of the steady model can be expressed as the following formula. However, u (t)=sin ω_{γ}t. The reference ω_{γ} represents a driving frequency.

\ddot{x}(t)+a₁\dot{x}(t)+a₀x(t)=b₀u(t) \dot{x}(0)=0, x(0)=0 [Expression 3]

When a differential equation of this expression is solved, the following transient model can be calculated. A first and second terms are attenuation terms. A third and fourth terms are stationary terms. While vibrating at a frequency (√(a₀−a₁²/4) that is slightly different from a resonance frequency, convergence to the stationary term with first-order lag characteristics 1/(s+a₁²/2) is performed.

$$x ( t ) = \frac{{b}_{0} {ω}_{r} \cdot ( \frac{{a}_{1}^{2}}{2} - {a}_{0} + {ω}_{y}^{2} )}{{d}_{e} \sqrt{{a}_{0} - \frac{{a}_{1}^{2}}{4}}} {e}^{- \frac{{a}_{1}^{2}}{2} t} sin \sqrt{{a}_{0} - \frac{{a}_{1}^{2}}{4}} t + \frac{{b}_{0} {ω}_{γ} {a}_{1}}{{d}_{e}} {e}^{- \frac{{a}_{1}^{2}}{2} t} cos \sqrt{{a}_{0} - \frac{{a}_{1}^{2}}{4}} t + \frac{{b}_{0} ( {a}_{0} - {ω}_{γ}^{2} )}{{d}_{e}} sin {ω}_{γ} t - \frac{{b}_{0} {a}_{1} {ω}_{γ}}{{d}_{e}} cos {ω}_{γ} t \qquad [ Expression 4 ]$$

$${d}_{e} = {( {a}_{0} - {ω}_{γ}^{2} )}^{2} + {a}_{1}^{2} {ω}_{γ}^{2}$$

In this way, in the steady model, an effect of the input is not considered. However, the transient model used in the present embodiment is a transient model that includes effects of the amplitude and the frequency of the driving sine wave.

Note that, in the example described above, as an example, a case has been described where the target amplitude is changed from 32° to 36°. However, the present embodiment can be applied to another target amplitude change. For example, even in a case where the target amplitude is changed from 36° to 40°, the same transient model Gp and the same target model Gd can be used. Alternatively, each of the transient model Gp and the target model Gd may be created for each change of the target amplitude value. For example, in each of a case where the target amplitude is changed from 32° to 36°, a case where the target amplitude is changed from 36° to 40°, a case where the target amplitude is changed from 34° to 38°, or the like, the transient model Gp and the target model Gd may be created for each case. In this case, the transient model Gp and the target model Gd may be selected and used according to the target amplitude change instruction from the zoom command unit 32. Furthermore, the transient model Gp and the target model Gd may be selected and used according to the target amplitude change instruction from the zoom command unit 32 by creating the transient model Gp and the target model Gd in a case where the target amplitude is reduced, as in a case where the target amplitude is changed from 36° to 32° or the like.

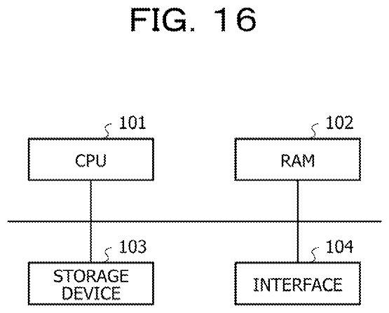

FIG. 16 is a block diagram for explaining hardware configurations of the light emission signal generation unit 21, the reference signal generation unit 22, the driving waveform generation unit 23, the measurement unit 24, the amplitude detection unit 25, the phase detection unit 26, the first PID controller 27, the angle signal generation unit 28, the amplitude detection unit 29, the phase detection unit 30, the second PID controller 31, the zoom command unit 32, the response improvement filter 41, and the target response filter 42. As illustrated in FIG. 16, each of these units is implemented by a central processing unit (CPU) 101, a random access memory (RAM) 102, a storage device 103, an interface 104, or the like. These components are coupled to one another by a bus or the like. The central processing unit (CPU) 101 is a central processing device. The CPU 101 includes one or more cores. The random access memory (RAM) 102 is a volatile memory that temporarily stores a program to be executed by the CPU 101, data to be processed by the CPU 101, or the like. The storage device 103 is a nonvolatile storage device. For example, a read only memory (ROM), a solid state drive (SSD) such as a flash memory, a hard disk to be driven by a hard disk drive, or the like may be used as the storage device 103. By executing a program stored in the storage device 103 by the CPU 101, the light emission signal generation unit 21, the reference signal generation unit 22, the driving waveform generation unit 23, the measurement unit 24, the amplitude detection unit 25, the phase detection unit 26, the first PID controller 27, the angle signal generation unit 28, the amplitude detection unit 29, the phase detection unit 30, the second PID controller 31, the zoom command unit 32, the response improvement filter 41, and the target response filter 42 are implemented. Note that the light emission signal generation unit 21, the reference signal generation unit 22, the driving waveform generation unit 23, the measurement unit 24, the amplitude detection unit 25, the phase detection unit 26, the first PID controller 27, the angle signal generation unit 28, the amplitude detection unit 29, the phase detection unit 30, the second PID controller 31, the zoom command unit 32, the response improvement filter 41, and the target response filter 42 may be implemented by an integrated circuit such as an application specific integrated circuit (ASIC) or a field programmable gate array (FPGA).

In the example described above, the MEMS mirror 12 is an example of a mirror that scans a reflection angle of laser light. The driving waveform generation unit 23 is an example of a driving waveform generation unit that generates a waveform of a driving signal for controlling an amplitude of the mirror, in response to an amplitude command value based on a target amplitude for defining a scanning range of the mirror. The response improvement filter 41 is an example of a feedforward unit that reflects a transient model in a case where the amplitude of the mirror transiently changes with time according to the driving signal in a case where the target amplitude is changed and a target model of a temporal change of the amplitude of the mirror on the amplitude command value through feedforward control. The zoom command unit 32 is an example of a command unit that commands the target amplitude according to a distance between a laser sensor and an object that emits laser light. The first PID controller 27 is an example of a feedback control unit that feedback controls the amplitude command value so as to reduce an error between an amplitude value commanded by the amplitude command value and a measured amplitude value of the mirror. The measurement unit 24 is an example of a measurement unit that measures the distance between the laser sensor and the object, using a time when laser light is emitted and a light received time of reflected light of the laser light from the object.

While the embodiments have been described above in detail, the present disclosure is not limited to such specific embodiments, and various modifications and alterations may be made within the scope of the present disclosure described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A laser sensor comprising:
a mirror configured to scan a reflection angle of laser light;
a driving waveform generation circuit configured to generate a waveform of a driving signal that controls an amplitude of the mirror, according to an amplitude command value based on a target amplitude that defines a scanning range of the mirror; and
a feedforward circuit configured to reflect a transient model in a case where the amplitude of the mirror transiently changes with time according to the driving signal in a case where the target amplitude is changed and a target model of a temporal change of the amplitude of the mirror on the amplitude command value through feedforward control.

2. The laser sensor according to claim 1, wherein the feedforward circuit reflects a ratio of the target model with respect to the transient model on a waveform of the driving signal.

3. The laser sensor according to claim 1, wherein the transient model is a model that represents a measured value of the temporal change of the amplitude of the mirror in a case where the target amplitude is changed.

4. The laser sensor according to claim 1, further comprising: a command circuit configured to command the target amplitude according to a distance between the laser sensor and an object that emits the laser light.

5. The laser sensor according to claim 1, further comprising:
a feedback control circuit configured to feedback control the amplitude command value so as to reduce an error between an amplitude value commanded by the amplitude command value and a measured amplitude value of the mirror, wherein
the feedback control circuit uses an amplitude value of the target model as an amplitude value commanded by the amplitude command value, in a case where the target amplitude has been changed.

6. The laser sensor according to claim 1, wherein the driving signal is a sine wave.

7. The laser sensor according to claim 1, wherein
the mirror is a micro electro mechanical system (MEMS) mirror that scans a reflection direction of the laser light with a first axis in a resonance direction and a second axis in a non-resonance direction, and
the amplitude of the mirror is an amplitude of the first axis.

8. The laser sensor according to claim 1, further comprising:
a measurement circuit configured to measure a distance between the laser sensor and an object, by using a time when the laser light is emitted and a light received time of reflected light of the laser light from the object.

9. A control method of a laser sensor comprising:
generating a waveform of a driving signal that controls an amplitude of a mirror configured to scan a reflection angle of laser light, according to an amplitude command value based on a target amplitude that defines a scanning range of the mirror; and
reflecting a transient model in a case where the amplitude of the mirror transiently changes with time according to the driving signal in a case where the target amplitude is changed and a target model of a temporal change of the amplitude of the mirror on the amplitude command value through feedforward control.

10. A non-transitory computer-readable recording medium storing a control program of a laser sensor comprising:
generating a waveform of a driving signal that controls an amplitude of a mirror configured to scan a reflection angle of laser light, according to an amplitude command value based on a target amplitude that defines a scanning range of the mirror; and
reflecting a transient model in a case where the amplitude of the mirror transiently changes with time according to the driving signal in a case where the target amplitude is changed and a target model of a temporal change of the amplitude of the mirror on the amplitude command value through feedforward control.
